(19) United States
(12) Patent Application Publication
(10) Pub. No.: US 2020/0200921 A1
(43) Pub. Date: Jun. 25, 2020

(54) Method for Operating a Radiometric Measuring Device, and Radiometric Measuring Device

(71) Applicant: Berthold Technologies GmbH & Co. KG, Bad Wildbad (DE)

(72) Inventors: Fritz BERTHOLD, Pforzheim (DE); Ewald FREIBURGER, Neulingen (DE)

(21) Appl. No.: 16/702,057

(22) Filed: Dec. 3, 2019

(30) Foreign Application Priority Data
Dec. 21, 2018 (DE) 10 2018 222 811.6

(51) Int. Cl. G01T 1/185; H01J 47/06

(52) U.S. Cl. CPC G01T 1/185; H01J 47/067

(57) ABSTRACT

A radiometric measuring device has a counting tube having an anode and a cathode, and is configured to determine a measurement variable depending on properties of ionizing radiation that impinges on the counting tube. In a first measurement mode, a constant first voltage is set between anode and cathode such that the counting tube operates as a proportional counting tube, and the measurement variable is determined depending on a current flowing between anode and cathode. In a second measurement mode, the current flowing between anode and cathode is controlled to a current setpoint value, wherein the voltage between anode and cathode serves as a manipulated variable of the current control, and the measurement variable is determined depending on the voltage between anode and cathode. In a third measurement mode, a constant second voltage is set between anode and cathode such that the counting tube operates as an ionization chamber, and the measurement variable is determined depending on the current flowing between anode and cathode. Either the first, second, or third measurement mode is activated depending on the current flowing between anode and cathode and/or depending on the voltage between anode and cathode.

### CROSS REFERENCE TO RELATED APPLICATION

This application claims priority under 35 U.S.C. § 119 from German Patent Application No. 10 2018 222 811.6, filed Dec. 21, 2018, the entire disclosure of which is herein expressly incorporated by reference.

### BACKGROUND AND SUMMARY OF THE INVENTION

The invention relates to a method for operating a radiometric measuring device and to a radiometric measuring device.

The invention is based on the object of providing a method for operating a radiometric measuring device and a radiometric measuring device which enable a measurement variable to be detected simply and reliably.

The invention achieves this object by means of a method for operating a radiometric measuring device and a radiometric measuring device according to the claimed invention.

The method according to the invention serves for operating a radiometric measuring device, wherein the radiometric measuring device comprises a conventional counting tube having an anode and a cathode.

The radiometric measuring device is configured to determine a measurement variable depending on properties of ionizing radiation that impinges on the counting tube, for example depending on the intensity of the ionizing radiation. With regard to these basic functions, reference should also be made to the relevant technical literature.

The method comprises the following steps.

In a first measurement mode, a constant first voltage between anode and cathode is set in such a way that the counting tube operates as a proportional counting tube. This is also referred to as operation of the counting tube with gas amplification. In the first measurement mode, the measurement variable is ascertained depending on a current flowing between anode and cathode. Moreover, with regard to the measurement mode of the counting tube as a proportional counting tube, reference should be made to the relevant technical literature. The first voltage can be for example in a voltage range of between 1000 V and 2000 V.

In a second measurement mode, the current flowing between anode and cathode is controlled to a predefinable current setpoint value, wherein the voltage between anode and cathode serves as a manipulated variable of the current control. In other words, the voltage between anode and cathode is set in such a way that the current flowing between anode and cathode corresponds to the predefinable current setpoint value. In the second measurement mode, the measurement variable is ascertained depending on the voltage between anode and cathode. The current setpoint value is typically in the picoamperes range.

In a third measurement mode, a constant second voltage different than the first voltage is applied between anode and cathode in such a way that the counting tube operates as an ionization chamber. In the third measurement mode, the measurement variable is ascertained depending on the current flowing between anode and cathode. With regard to the fundamental properties of the measurement mode as ionization chamber, reference should be made to the relevant technical literature. The second voltage can be for example in a voltage range of between 300 V and 500 V.

According to the invention, either the first measurement mode, the second measurement mode or the third measurement mode is set or activated depending on the current flowing between anode and cathode and/or depending on the voltage between anode and cathode.

In accordance with one embodiment, in the second measurement mode, the counting tube operates as a proportional counting tube, i.e. the voltage between anode and cathode is varied within a voltage range that causes the counting tube to act as a proportional counting tube.

In accordance with one embodiment, proceeding from the active first measurement mode, the second measurement mode is activated as soon as the current flowing between anode and cathode exceeds a current threshold value. The current threshold value is typically in the picoamperes range and may depend on the design of the counting tube.

In accordance with one embodiment, the current setpoint value is chosen on the basis of the current threshold value. In particular, the current setpoint value and the current threshold value are chosen to be identical.

In accordance with one embodiment, proceeding from the activated second measurement mode, the third measurement mode is activated as soon as the voltage between anode and cathode falls below a voltage threshold value. The voltage threshold value can be for example in a voltage range of between 1000 V and 1500 V and may depend on counting tube parameters, such as, for example, the gas used, the filling pressure, etc.

In accordance with one embodiment, the measurement variable is a dose power.

The radiometric measuring device according to the invention comprises a conventional counting tube having an anode and a cathode.

The radiometric measuring device further comprises a drivable voltage generating unit configured to generate a settable voltage between anode and cathode in a driving-dependent manner.

The radiometric measuring device furthermore comprises a control unit, for example in the form of a microprocessor, configured to drive the voltage generating unit, to detect a current flowing between anode and cathode and to detect the voltage present between anode and cathode. The control unit is further configured to drive the radiometric measuring device in such a way that a method described above is carried out.

In the second measurement mode, given a known counting tube characteristic curve, the current flowing between anode and cathode can be kept constant. This keeping constant is effected by means of a control loop, for example, which is implemented by way of the tracking of the gas amplification by varying the applied (high) voltage between anode and cathode. The value of the applied voltage given a constant current is thus the measurement signal to be evaluated for the measurement variable, for example radiation intensity.

The voltage can be tracked with a sufficiently short time constant, for example approximately 1 second.

A calibration of the radiometric measuring device in the second measurement mode, i.e. with a predefined current setpoint value, can be effected for example by means of a calibration emitter having a known radiation intensity with the counting tube being in a defined geometric position.

Without or with very low radiation intensity, the current can no longer be controlled to the current setpoint value since the voltage as manipulated variable would assume impermissibly high values and reach the range of limited proportionality, which should be avoided. In this case, therefore, the voltage is not increased further and the measurement variable is ascertained once again on the basis of the variable current.

This results in three measurement modes or measurement ranges:

Measurement mode 1: Constant voltage range with very low radiation intensities or without radiation intensity.

Measurement mode 2: Constant current range with radiation intensities equal to or greater than a previously known calibration intensity.

Measurement mode 3: Constant voltage range at the ionization chamber plateau without gas amplification at very high intensities.

These three measurement modes or measurement ranges can transition continuously into one another. If appropriate, a hysteresis can be provided between the transitions. The joining of the constant current range to the ionization chamber range can be adapted, if appropriate, by way of a variation of an electronic gain.

The measurement of current and voltage can be carried out cyclically by means of an AD converter, the converted values being evaluated in a microcontroller, for example.

By means of the measurement mode switchover according to the invention, by way of example, recombination effects and saturation effects in the counting tube can be minimized. Furthermore, the counting gas used in the counting tube can be protected from excessively rapid “consumption”.

Other objects, advantages and novel features of the present invention will become apparent from the following detailed description of one or more preferred embodiments when considered in conjunction with the accompanying drawings.

### BRIEF DESCRIPTION OF THE DRAWINGS

FIG. 1 schematically shows a radiometric measuring device.

FIG. 2 schematically shows a gain as a function of a voltage and a current in logarithmic representation.

### DETAILED DESCRIPTION OF THE DRAWINGS

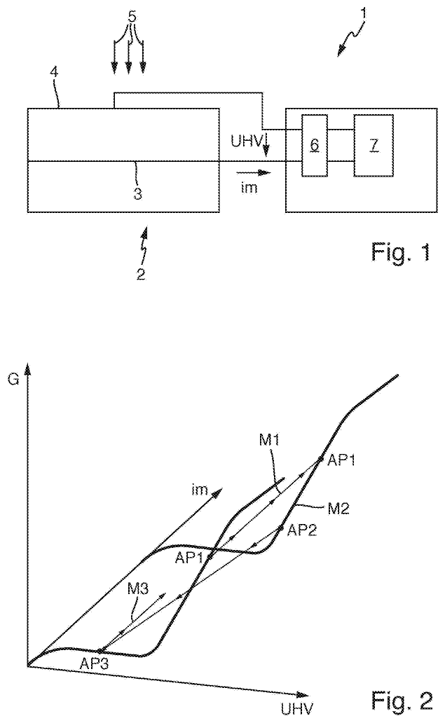

FIG. 1 shows a radiometric measuring device 1 comprising a counting tube 2. The counting tube 2 comprises an anode 3 and a cathode 4 in a conventional manner.

The radiometric measuring device 1 further comprises a drivable voltage generating unit 6 configured to generate a settable (high) voltage UHV between anode 3 and cathode 4. In this respect, reference should also be made to the relevant technical literature.

The radiometric measuring device 1 further comprises a control unit 7 configured to drive the voltage generating unit 6 for generating a desired voltage UHV and to detect a current im flowing between anode 3 and cathode 4 and the generated voltage UHV.

The radiometric measuring device 1 is configured to determine a measurement variable, for example in the form of a dose power, depending on properties of ionizing radiation 5 that impinges on the counting tube 2. The properties of the ionizing radiation 5 can be the intensity of the ionizing radiation 5.

The measuring method carried out by means of the radiometric measuring device 1 will be explained in greater detail with reference to FIG. 2.

FIG. 2 schematically shows, in a three-dimensional coordinate system, a gain G (plotted logarithmically) as a function of the (counting tube) voltage UHV and the (counting tube) current im.

FIG. 2 shows by way of example the dose-power-dependent trajectory or path according to the invention on the gain characteristic curve, beginning with a low dose power at the operating point AP1 on the left in the direction of increasing dose powers at the operating point AP1 on the right, then with further increasing dose power in the direction of operating point AP2, then with even further increasing dose power in the direction of AP3 and finally with even further increasing dose power from the operating point AP3 in the direction of increasing currents im.

In a first measurement mode M1 between the operating points AP1, a constant voltage UHV between anode 3 and cathode 4 is set in such a way that the counting tube 2 operates as a proportional counting tube. For this case, the measurement variable is ascertained depending on the current im flowing between anode 3 and cathode 4.

In a second measurement mode M2 between the operating points AP1 and AP2, the current im flowing between anode 3 and cathode 4 is controlled to a current setpoint value, wherein the voltage UHV between anode 3 and cathode 4 serves as a manipulated variable of the current control. For this case, the measurement variable is ascertained depending on the voltage UHV between anode 3 and cathode 4.

In a third measurement mode M3 beginning with the operating point AP3, a constant voltage UHV between anode 3 and cathode 4 is set in such a way that the counting tube 2 operates as an ionization chamber. The measurement variable is then determined depending on the current im flowing between anode 3 and cathode 4.

The first measurement mode M1, the second measurement mode M2 or the third measurement mode M3 is selected depending on the current im flowing between anode 3 and cathode 4 and/or depending on the voltage UHV between anode 3 and cathode 4.

At the operating point AP1, the voltage UHV is kept constant and the current im is measured. As soon as a specific, previously defined current im is reached, it is fixed and the voltage UHV is reduced until the operating point AP2 is reached. A switchover to the operating point AP3 is then made. The latter lies at the ionization chamber plateau. The uninterrupted joining of the measurement range between AP2 and AP3 can be achieved by suitable adaptation of the electronic gain. At the operating point AP3, once again the voltage UHV is fixed and the current im is measured.

The foregoing disclosure has been set forth merely to illustrate the invention and is not intended to be limiting. Since modifications of the disclosed embodiments incorporating the spirit and substance of the invention may occur to persons skilled in the art, the invention should be construed to include everything within the scope of the appended claims and equivalents thereof.

What is claimed is:

1. A method for operating a radiometric measuring device,
wherein the radiometric measuring device comprises a counting tube having an anode and a cathode, and
wherein the radiometric measuring device is configured to determine a measurement variable depending on properties of ionizing radiation that impinges on the counting tube,
wherein the method comprises the steps of:
(i) in a first measurement mode,
setting a constant first voltage between anode and cathode such that the counting tube operates as a proportional counting tube, and
determining the measurement variable depending on a current flowing between the anode and the cathode;
(ii) in a second measurement mode,
controlling the current flowing between the anode and the cathode to a current setpoint value, wherein the voltage between the anode and the cathode serves as a manipulated variable of the current control, and
determining the measurement variable depending on the voltage between anode and cathode; and
(iii) in a third measurement mode,
setting a constant second voltage between the anode and the cathode such that the counting tube operates as an ionization chamber, and
determining the measurement variable depending on the current flowing between the anode and the cathode; and
activating either the first measurement mode, the second measurement mode or the third measurement mode depending on the current flowing between the anode and the cathode and/or depending on the voltage between the anode and the cathode.

2. The method according to claim 1, wherein
the counting tube operates as a proportional counting tube in the second measurement mode.

3. The method according to claim 1, wherein
proceeding from the activated first measurement mode, the second measurement mode is activated as soon as the current flowing between the anode and the cathode exceeds a current threshold value.

4. The method according to claim 3, wherein
the current setpoint value is chosen on the basis of the current threshold value.

5. The method according to claim 4, wherein
the current setpoint value and the current threshold value are chosen to be identical.

6. The method according to claim 1, wherein
proceeding from the activated second measurement mode, the third measurement mode is activated as soon as the voltage between the anode and the cathode falls below a voltage threshold value.

7. The method according to claim 1, wherein
the measurement variable is a dose power.

8. A radiometric measuring device, comprising:
a counting tube having an anode and a cathode;
a drivable voltage generating unit configured to generate a settable voltage between the anode and the cathode; and
a control unit configured to drive the voltage generating unit and to detect a current flowing between the anode and the cathode, wherein
the control unit is configured to drive the radiometric measuring device so as to carry out the acts of:
(i) in a first measurement mode,
setting a constant first voltage between anode and cathode such that the counting tube operates as a proportional counting tube, and
determining the measurement variable depending on a current flowing between the anode and the cathode;
(ii) in a second measurement mode,
controlling the current flowing between the anode and the cathode to a current setpoint value, wherein the voltage between the anode and the cathode serves as a manipulated variable of the current control, and
determining the measurement variable depending on the voltage between anode and cathode; and
(iii) in a third measurement mode,
setting a constant second voltage between the anode and the cathode such that the counting tube operates as an ionization chamber, and
determining the measurement variable depending on the current flowing between the anode and the cathode; and
activating either the first measurement mode, the second measurement mode or the third measurement mode depending on the current flowing between the anode and the cathode and/or depending on the voltage between the anode and the cathode.
